(19) United States
(12) Patent Application Publication
(10) Pub. No.: US 2011/0133643 A1
(43) Pub. Date: Jun. 9, 2011

(54) LED SPOTLIGHTS

(75) Inventors: Xinshen XUE, Shenzhen (CN); Zhenliang LIU, Shenzhen (CN)

(73) Assignee: CIVILIGHT QIDONG LIGHTING TECHNOLOGY CO., LTD., Jiangsu (CN)

(21) Appl. No.: 12/781,606

(22) Filed: May 17, 2010

(30) Foreign Application Priority Data
Dec. 4, 2009 (CN) 200910188611.2

(51) Int. Cl. H01K 1/62

(52) U.S. Cl. 315/32

(57) ABSTRACT

An LED spotlight includes a light body, a base securely fixed to the light body, and a light cover fixedly connected to the light body. A power supply is disposed on an inside of the base. The light body includes a dissipating heat body firmly connected to the base, a dissipating heat base plate displaced on the dissipating heat body and coupled to the power supply, a plurality of LED lamps fixedly connected to the dissipating heat base plate, and an insulation lamp cup made of glass or transparent plastic disposed over the LED lamps. The lamp cup is provided with at least one lens or reflective bowl, and the lamp cup is integrated with the at least one lens or reflective bowl. The LED spotlight in accordance with the present invention has a simple structure and a low cost, and is safe to use.

### TECHNICAL FIELD

The present invention relates to lighting devices, and more particularly, to an LED spotlight.

### BACKGROUND

Shells of most of the existing LED spotlights are made of metal materials, and all of LED spotlights individually use plastic or metal bowl or plastic lens to focus light. However, the conventional LED spotlights with such a structure have many parts, and the producing process is more complex, the producing cost of LED spotlights is higher, the defective products are relatively higher, and thus, a waste of resources comes into being. Also, due to conductivity of metal materials, there is an insecurity factor that the shell of the current LED spotlight is made of metal materials.

There is, therefore, a need for an LED spotlight, which has a simple structure and a low cost, and is safe to use.

### SUMMARY

In accordance with an embodiment of the present invention, an LED spotlight includes a light body, a base securely fixed to the light body; and a light cover fixedly connected to the light body. A power supply is disposed on an inside of the base. The light body includes a dissipating heat body firmly connected to the base, a dissipating heat base plate displaced on the dissipating heat body and coupled to the power supply, a plurality of LED lamps fixedly connected to the dissipating heat base plate, and an insulation lamp cup made of glass or transparent plastic disposed over the LED lamps. The lamp cup is provided with at least one lens or reflective bowl, and the lamp cup is integrated with the at least one lens or reflective bowl.

Preferably, the lamp cup and the at least one lens or reflective bowl is integratedly molded.

Preferably, the at least one lens is a single or composite lens.

Preferably, the at least one reflective bowl is a single or composite reflective bowl.

Preferably, the lamp cup is made of glass or plastic.

Preferably, the dissipating heat body and the base are made from insulating and heat-conducting ceramic material.

Other objects, advantages and novel features of the present invention will become more apparent from the following detailed description when taken in conjunction with the accompanying drawings, in which:

### BRIEF DESCRIPTION OF THE DRAWINGS

FIG. 1 is a sectional view of an LED spotlight in accordance with a first embodiment of the present invention, the LED spotlight including an insulation lamp cup with a separated lens, and a vaulted light cover;

FIG. 2 is similar to FIG. 1, but the LED spotlight including a flat light cover;

FIG. 3 is an exploded view of the LED spotlight in FIG. 2;

FIG. 4 is a sectional view of an LED spotlight in accordance with a second embodiment of the present invention, the LED spotlight including an insulation lamp cup with a composite lens, and a vaulted light cover;

FIG. 5 is an exploded view of the LED spotlight in FIG. 4, but the LED spotlight including a flat light cover;

FIG. 6 is a sectional view of an LED spotlight in accordance with a third embodiment of the present invention, the LED spotlight including an insulation lamp cup with an integrated composite lens, and a vaulted light cover;

FIG. 7 is an exploded view of the LED spotlight in FIG. 6;

FIG. 8 is a sectional view of an LED spotlight in accordance with a fourth embodiment of the present invention, the LED spotlight including an insulation lamp cup with a single reflective bowl, and a vaulted light cover;

FIG. 9 is similar to FIG. 8, but the LED spotlight including a flat light cover;

FIG. 10 is an exploded view of the LED spotlight in FIG. 9;

FIG. 11 is a sectional view of an LED spotlight in accordance with a fifth embodiment of the present invention, the LED spotlight including an insulation lamp cup with a composite reflective bowl, and a vaulted light cover; and

FIG. 12 is an exploded view of the LED spotlight in FIG. 11, but the LED spotlight including a flat light cover. Wherein, 100—light body; 101—dissipating heat body; 102—dissipating heat base plate; 103—LED light; 104—lamp cup; 114—lens; 124—reflective bowl; 200—base; 300—light cover; 400—power supply.

### DETAILED DESCRIPTION OF THE PREFERRED EMBODIMENTS

Objects, advantages and embodiments of the present invention will be explained below in detail with reference to the accompanying drawings. However, it is to be appreciated that the following description of the embodiment(s) is merely exemplary in nature and is no way intended to limit the invention, its application, or uses.

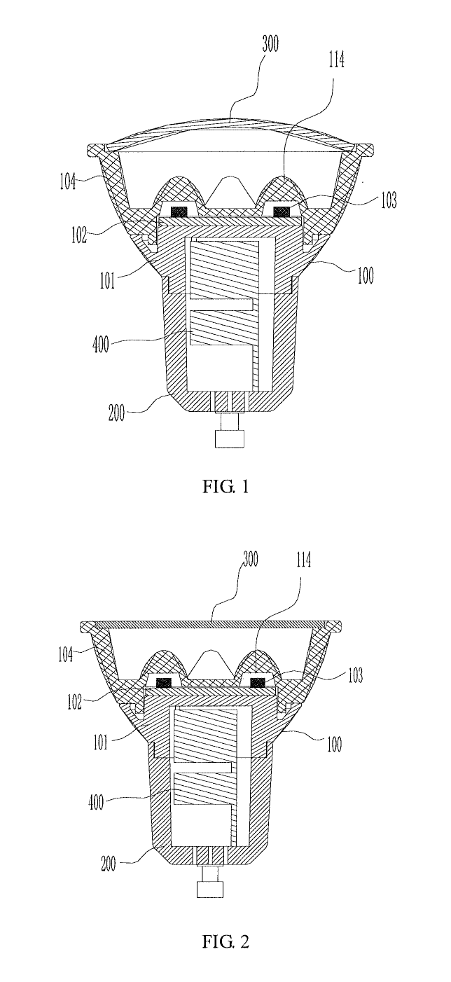

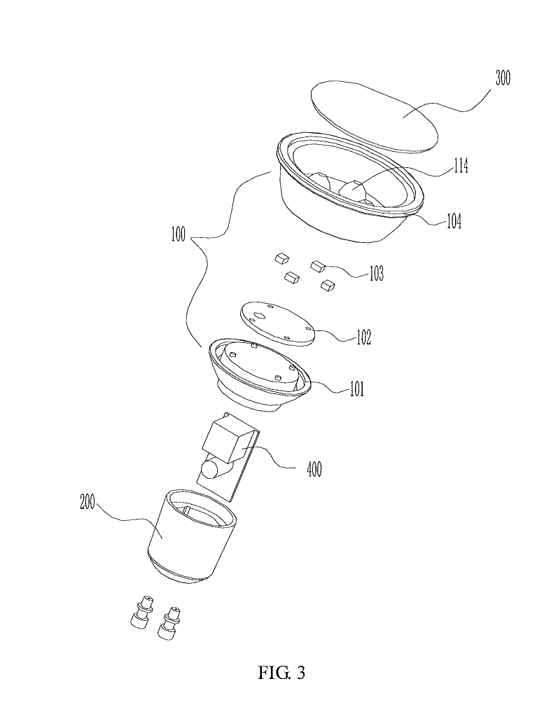

Referring to FIGS. 1, 2 and 3, an upper portion of a dissipating heat body 101 is tightly connected with a dissipating heat base plate 102, and a bottom portion of the dissipating heat body 101 is connected with a base 200. A plurality of LED lamps 103 disposed on the dissipating heat base plate 102 is seamlessly welded into the dissipating heat base plate 102 through solder paste. An insulation lamp cup 104 with a single separated lens 114 is displaced over the LED lamps 103 and firmly secured to the dissipating heat body 101. And then, a transparent vaulted cover or flat cover 300 is fixed on the insulation lamp cup 104 with the single separated lens 114. Additionally, a power supply 400 is placed on an inner portion of the base 200, and the dissipating heat base plate 102 is coupled to the power supply 400 to achieve electrical conduction.

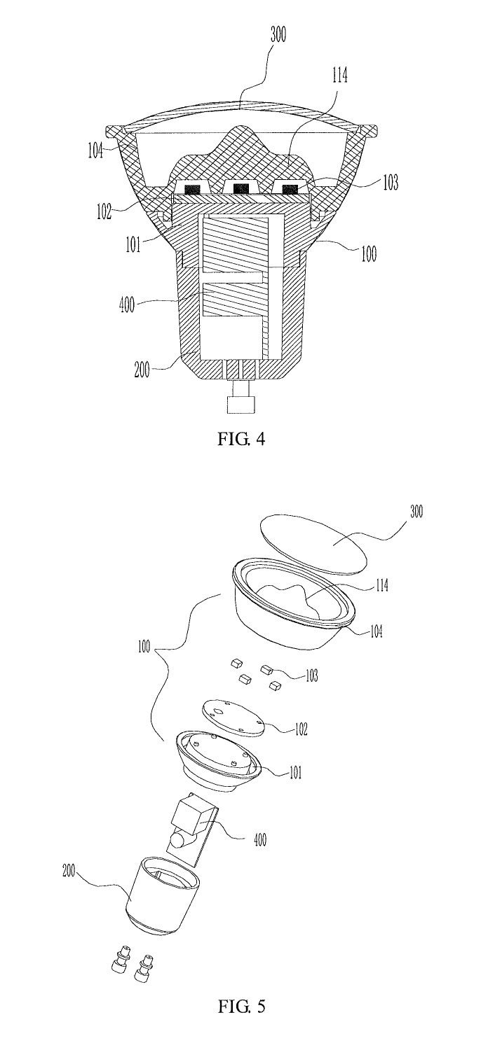

Referring to FIGS. 4-5, an upper portion of a dissipating heat body 101 is tightly connected with a dissipating heat base plate 102, and a bottom portion of the dissipating heat body 101 is connected with a base 200. A plurality of LED lamps 103 disposed on the dissipating heat base plate 102 is seamlessly welded into the dissipating heat base plate 102 through solder paste. An insulation lamp cup 104 with a composite lens 114 is displaced over the LED lamps 103 and firmly secured to the dissipating heat body 101. The composite lens 114 is an integrated lens including a plurality of lenses. And then, a transparent vaulted cover or flat cover 300 is fixed on the insulation lamp cup 104 with the composite lens 114. Additionally, a power supply 400 is placed on an inner portion of the base 200, and the dissipating heat base plate 102 is coupled to the power supply 400 to achieve electrical conduction.

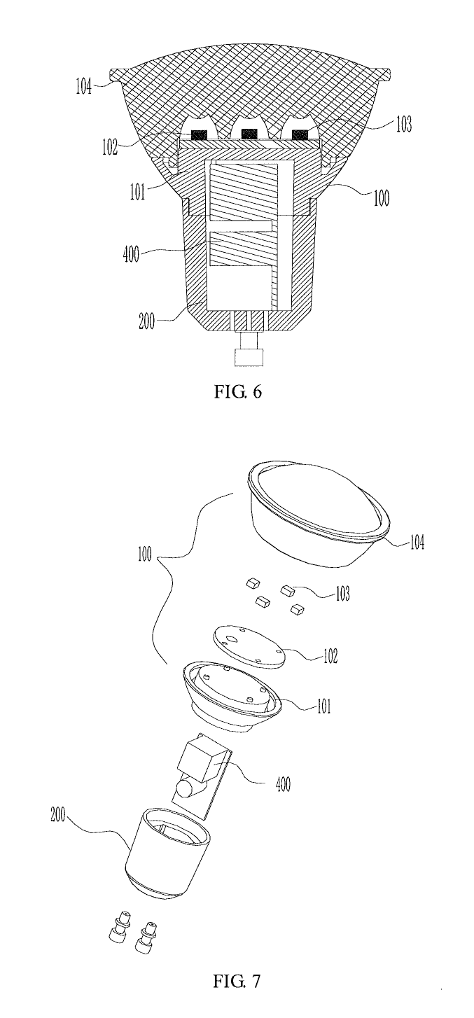

Referring to FIGS. 6-7, an upper portion of a dissipating heat body 101 is tightly connected with a dissipating heat base plate 102, and a bottom portion of the dissipating heat body 101 is connected with a base 200. A plurality of LED lamps 103 disposed on the dissipating heat base plate 102 is seamlessly welded into the dissipating heat base plate 102 through solder paste. A composite insulation lamp cup 104 which integrates a lens, a lamp cup and lamp cover, is displaced over the LED lamps 103 and firmly secured to the dissipating heat body 101. Additionally, a power supply 400 is placed on an inner portion of the base 200, and the dissipating heat base plate 102 is coupled to the power supply 400 to achieve electrical conduction.

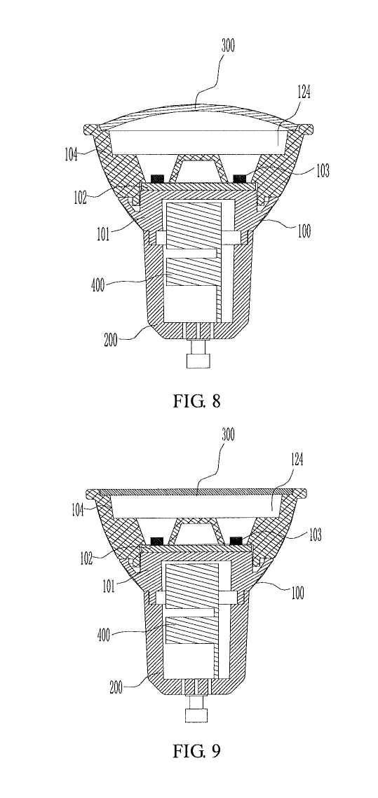

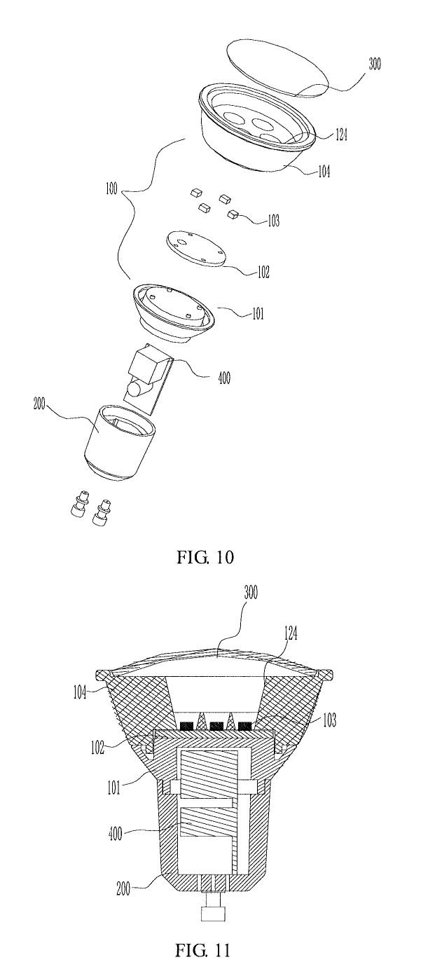

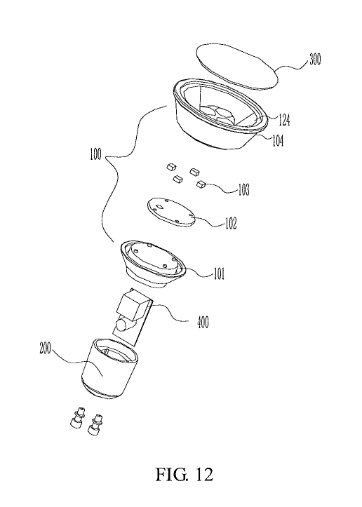

Referring to FIGS. 8-12, an upper portion of a dissipating heat body 101 is tightly connected with a dissipating heat base plate 102, and a bottom portion of the dissipating heat body 101 is connected with a base 200. A plurality of LED lamps 103 disposed on the dissipating heat base plate 102 is seamlessly welded into the dissipating heat base plate 102 through solder paste. An insulation lamp cup 104 with a single or composite reflective bowl 124 is displaced over the LED lamps 103 and firmly secured to the dissipating heat body 101. The ray of light from each LED lamp 103 is reflected via a small bowl defined in the composite reflective bowl 124, and then is integratedly reflected out via the composite reflective bowl 124. Finally, a transparent vaulted cover or flat cover 300 is fixed on the insulation lamp cup 104 with the reflective bowl 124. Additionally, a power supply 400 is placed on an inner portion of the base 200, and the dissipating heat base plate 102 is coupled to the power supply 400 to achieve electrical conduction.

The working principle of the present invention is as follows:

An LED spotlight according to the present invention includes a light body 1, a base 2 securely fixed to a bottom of the light body 1, and a light cover 3 fixedly connected to a top of the light body 1. A power supply 4 is disposed on an inside of the base 2. The light body 1 includes a dissipating heat body 101, a dissipating heat base plate 102 displaced on the dissipating heat body 101, a plurality of LED lamps 103 fixedly connected to the dissipating heat base plate 102, and a lamp cup 104 disposed over the LED lamps 103. The lamp cup 104 is provided with at least one lens 114 or reflective bowl 124. The dissipating heat body 101 is securely connected to the base 2. The dissipating heat base plate 102 is coupled to the power supply 400. The lamp cup 104 is an insulator. The input voltage gains access to a lamp cap of the LED spotlight through an isolated or non-isolated power supply 4 in a constant current mode for one or more LED lamps 103 to provide a working voltage, thereby lighting LED lamp 103. The light emitted from the LED lamp 103 forms an beam in any angle through the lamp cup 104 with the lens 114 or a reflective bowl 124 to achieve a desired light output. The lamp cup 104 is made from the transparent crystal insulating material, while the dissipating heat body 101 and the base 2 are made from the ceramic material. In the present embodiment, the transparent material includes glass or other crystal material, transparent plastic such as transparent PC, transparent PMMA and so on.

The light body in the present patent application is distinctly different from the conventional light body using the metal shell. The light body in the present patent application is made of transparent material and ceramic material and integrates with the lamp cup which is provided with the lens or reflective bowl. However, the conventional lamp cup is divided with the plastic lens or reflective bowl made of metal or plastic. Therefore, the light body in the present patent application saves material and achieves the best optical effects through the use of the most simple structure and process. The manufacture of the LED spotlight of the present patent application has lower cost, simple structure and process, and the used material is more environment-friendly.

The LED spotlight in accordance with the present invention has the following advantages: firstly, the number of components is reduced because the lamp cup is integrated with the reflective bowl or the lens, reducing, the process is simplified, and the cost and energy are saved. Secondly, the lamp cup is made of transparent insulation material, and the dissipating heat body and the base are made of ceramic material, thus, the selected materials is more environment-friendly. Thirdly, the used material for manufacturing the light body is an insulation and environment-friendly material, safe and reliable material.

The present invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. An LED spotlight, comprising:
a light body;
a base securely fixed to a bottom of the light body; and
a light cover fixedly connected to a top of the light body;
a power supply disposed on an inside of the base, wherein the light body comprises a dissipating heat body firmly connected to the base, a dissipating heat base plate displaced on the dissipating heat body and coupled to the power supply, a plurality of LED lamps fixedly connected to the dissipating heat base plate, and a transparent insulation lamp cup disposed over the LED lamps, and wherein the lamp cup is provided with at least one lens or reflective bowl, and the lamp cup is integrated with the at least one lens or reflective bowl.

2. The LED spotlight as claimed in claim 1, wherein the lamp cup and the at least one lens or reflective bowl is integratedly molded.

3. The LED spotlight as claimed in claim 1, wherein the at least one lens is a single or composite lens.

4. The LED spotlight as claimed in claim 1, wherein the at least one reflective bowl is a single or composite reflective bowl.

5. The LED spotlight as claimed in claim 1, wherein the lamp cup is made of glass or plastic.

6. The LED spotlight as claimed in claim 1, wherein the dissipating heat body and the base are made from insulating and heat-conducting ceramic material.

7. An LED spotlight, comprising:
a light body;
a base securely fixed to the light body; and
a light cover fixedly connected to the light body;
a power supply disposed on an inside of the base, wherein the light body comprises a dissipating heat body firmly connected to the base, a dissipating heat base plate displaced on the dissipating heat body and coupled to the power supply, a plurality of LED lamps fixedly connected to the dissipating heat base plate, and a lamp cup made of glass or transparent plastic disposed over the LED lamps, and wherein the lamp cup is integrated with the at least one lens or reflective bowl.

8. The LED spotlight as claimed in claim 7, wherein the lamp cup and the at least one lens or reflective bowl is integratedly molded.

9. The LED spotlight as claimed in claim 7, wherein the at least one lens is a single or composite lens.

10. The LED spotlight as claimed in claim 8, wherein the at least one reflective bowl is a single or composite reflective bowl.

11. The LED spotlight as claimed in claim 7, wherein the dissipating heat body and the base are made from insulating and heat-conducting ceramic material.
